(19) United States
(12) Patent Application Publication
(10) Pub. No.: US 2009/0175580 A1
(43) Pub. Date: Jul. 9, 2009

(54) Hybrid optical/electrical connector and adapter

(76) Inventors: Wenzong Chen, Naperville, IL (US); Barbara Grzegorzewska, Riverside, IL (US); Mark R. Matuszewski, Elmhurst, IL (US); Igor Grois, Northbrook, IL (US)

Correspondence Address: MOLEX INCORPORATED, 2222 WELLINGTON COURT, LISLE, IL, 60532, US

(21) Appl. No.: 11/920,939

(22) PCT Filed: May 10, 2006
(86) PCT No.: PCT/IB2006/001252

§ 371 Date: Feb. 6, 2009

Related U.S. Application Data
(63) Continuation of application No. 11/134,741, filed on May 20, 2005, now abandoned.

(51) Int. Cl. G02B 6/38

(52) U.S. Cl. 385/75

(57) ABSTRACT

A hybrid optical/electrical connector and mated adapter for terminating at least one hybrid optical/electrical cable containing an optical fiber and a conductor. The connector includes a crimp body having an elongated conductive insert with an interior passage for receiving the optical fiber and a non-conductive shell covering the insert. The insert has a contact portion exposed through the shell and an end extending beyond the shell for electrical engagement with the hybrid cable conductor. The adapter includes a non-conductive housing with a plug connector receiving channel. Within the plug receiving channel, a conductor extends longitudinally. The conductor has a contact point within the channel in alignment with the exposed contact portion of the insert so that when the connector is inserted within the receiving channel, the exposed contact portion of the insert and the conductor contact point of the adapter are in electrical engagement with one another.

### TECHNICAL FIELD

This invention relates generally to connector hardware for data cables, and more specifically, to hybrid optical/electrical connectors and adapters that contain both electrical and optical connections inside a single jack.

### BACKGROUND

The growth in optical communications has been fueled by the extraordinary bandwidth that is available on optical fiber. Such bandwidth enables, among other things, relatively low-cost transmission of millions of telephone conversations and television channels over hair-thin optical fibers that are now commonplace in many places around the globe.

However, the high bandwidth of optical cables alone cannot satisfy some very simple needs that are easily handled by electrical cables. For example, electrical cables are the most practical way to provide power. They also provide a simple means for transferring data, interfacing with the existing communications infrastructure (e.g., non-optical telephone equipment) or carrying signal information regarding a cable, such as a patch cord identity or a safety signal for cutting off transmissions through the cable when it is unplugged.

Consequently, hybrid (i.e., optical/electrical) cables have been designed to combine the advantages of electrical conductors and optical fibers. Known hybrid cables have at least one electrical conductor included in a single cable with one or more optical fibers.

To connect these hybrid cables, either separate optical and electrical connectors are used, or alternatively, specially designed hybrid (i.e., optical/electrical) connectors are used. Communications cables are usually interconnected at patch panels. Patch panels are commonly used to interconnect specific customers and equipment (e.g., phones, telecommunication switches, etc.) to other specific customers and equipment, and it is imperative that the interconnections be made accurately and reliably. Space is at a premium in such patch panels and an optical/electrical connector arrangement having a small footprint (i.e., cross-section area) is desirable, as is the ability to easily insert and remove closely spaced connectors in the patch panel. Also, industry standard connector footprints are becoming increasingly popular because they facilitate greater interoperability. Thus, it is also desirable for an optical/electrical connector arrangement to have an industry standard footprint.

Some known hybrid connectors, such as the one disclosed in U.S. Pat. No. 6,588,938 to Lampert et al., include both optical and electrical connectors formed integrally in a single housing. However, these hybrid connectors have non-standard footprints and do not conform to industry standards for connector cross sections. Also, these hybrid connectors have relatively complicated designs and structures that are not as cost effective as they could be from a manufacturing perspective.

In view of the foregoing, there is a need for an improved hybrid connector that has a relatively small and/or industry standard cross-section area, a reduced number of parts and simplified design for improving manufacturability, and the ability to easily install or remove from a densely packed patch panel.

### SUMMARY

It is an advantage of the present invention to provide a novel hybrid optical/electrical connector and mated adapter that fulfill the above-described needs.

In accordance with an embodiment of the invention, the hybrid optical/electrical connector includes a crimp body having an elongated conductive insert with an interior passage for receiving the optical fiber and a non-conductive shell covering the insert. The insert has a contact portion exposed through the shell and an end extending beyond the shell for electrical engagement with the hybrid cable conductor. This unique structure of the crimp body greatly improves the manufacturability of the hybrid connector.

The adapter includes a non-conductive housing with a plug connector receiving channel. Within the plug receiving channel, a conductor extends longitudinally. The conductor has a contact point within the channel in alignment with the exposed contact portion of the insert so that when the hybrid connector is inserted within the receiving channel, the exposed contact portion of the insert and the conductor contact point of the adapter are in electrical engagement with one another.

An advantageous aspect of the invention provides that the hybrid connector and adapter can have cross-sections and features conforming to the physical requirements for industry standard connectors, such as an RJ-45 plug connector, an LC type connector or the like. By adopting industry standard form factors and features, the interoperability of the novel hybrid connector and adapter is greatly enhanced.

Other aspects, features, embodiments, processes and advantages of the invention will be or will become apparent to one with skill in the art upon examination of the following figures and detailed description. It is intended that all such additional features, embodiments, processes and advantages be included within this description, be within the scope of the invention, and be protected by the accompanying claims.

### BRIEF DESCRIPTION OF THE DRAWINGS

It is to be understood that the drawings are solely for purpose of illustration and do not define the limits of the invention. Furthermore, the components in the figures are not necessarily to scale, emphasis instead being placed upon illustrating the principles of the invention. In the figures, like reference numerals designate corresponding parts throughout the different views.

FIG. 1 is a cross-sectional view of a hybrid cable containing both optical and electrical transmission media.

FIG. 2 is an exploded perspective view of a hybrid optical/electrical connector system in accordance with an exemplary embodiment of the present invention.

FIG. 3 is an exploded perspective view of one of the hybrid optical/electrical connectors shown in FIG. 2.

FIG. 4 is a partial cut-away view showing details of the connector crimp body included in the hybrid optical/electrical connectors of FIGS. 2-3.

FIG. 5 is a partial cross-sectional view of one of the hybrid optical/electrical connectors of FIG. 2.

FIGS. 6A-C are various views of the adapter shown in FIG. 2.

FIG. 7 is partial cross-sectional view showing the hybrid optical/electrical connector inserted within the hybrid adapter.

FIGS. 8A-B are various views of an alternative structure of the hybrid adapter, which includes external soldering joints.

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

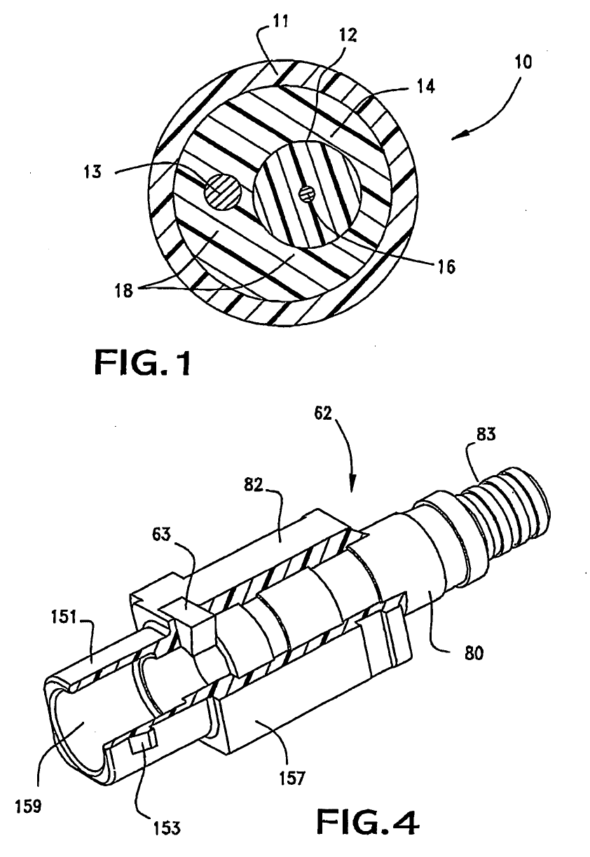

Turning now to the drawings, and in particular to FIG. 1, there is illustrated a cross-sectional view of an exemplary hybrid cable 10 containing both optical and electrical transmission media. The cable 10 contains a buffered optical fiber 12 and an electrical conductor 13. These transmission media 12,13 are surrounded by a number of filamentary (yarn-like) strength members 18 that are preferably made from aramid fibers. The strength members 18 impart significant tensile strength to the cable 10 and protect the optical fiber 12 and electrical conductor 13 from undue strain that may be applied to the cable 10 during service and handling.

In this example cable, the cable 10 includes an outer jacket (or sheathing) 11 made of a suitable protective material, such as polyvinyl chloride (PVC). The buffered optical fiber 12 comprises a glass fiber 16 (diameter about 125 microns) having one or more layers of protective coating material and a layer of a polymeric material 14 such as nylon to buffer the glass fiber 16. Alternatively, buffered optical fiber 12 can be a plastic optical fiber. The electrical conductor 13 is preferably an un-insulated copper wire.

Whereas only one optical fiber and one electrical conductor are shown, it is understood that the cable 10 could contain any number of optical fibers and electrical conductors without departure from the invention.

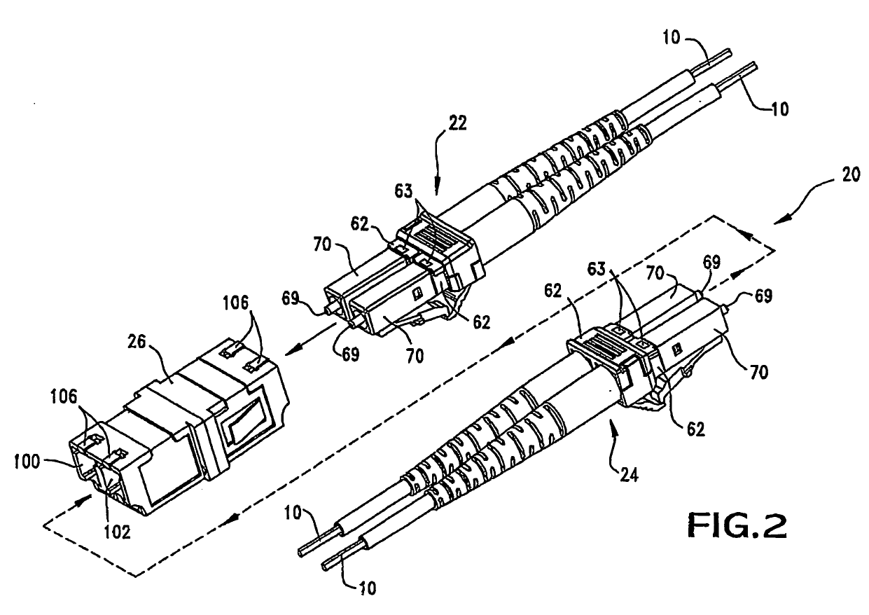

Four of the cables 10 are shown connected to two optical/electrical (hybrid) duplex plug connectors 22,24 in FIG. 2. FIG. 2 illustrates a novel hybrid LC duplex connector system 20 in accordance with an exemplary embodiment of the present invention. In addition to the connectors 22,24, the system 20 also includes a hybrid LC duplex adapter 26.

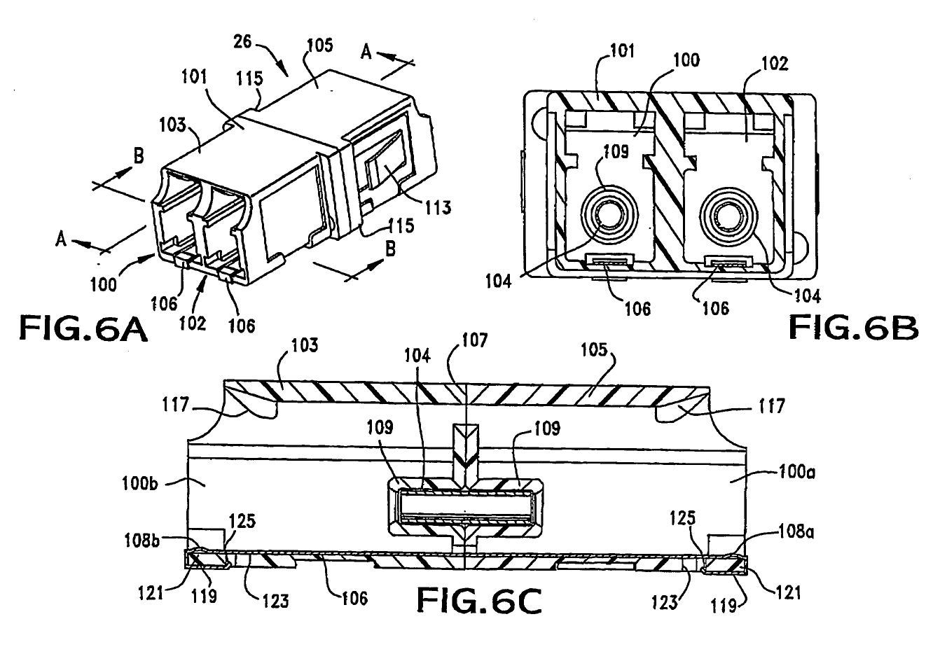

The connectors 22,24 are mated inside the adapter 26 within respective plug connector receiving channels 100,102. When mating is completed, two optical paths and two electrical paths via the hybrid cables 10 are established inside the adapter 26. The two optical paths are completed by mating together, respectively, the four terminal ends 69 of the four optical fibers 12 of the hybrid cables 10 when the connectors 22,24 are fully inserted into the adapter 26. The two electrical paths are completed when four exposed conducting portions 63 of connector crimp bodies 62 contact, respectively, two conductors 106 longitudinally extending through the length of each plug connector receiving channel 100,102 of the adapter 26. The configuration of the adapter conductors 106 is more fully illustrated with reference to FIGS. 6A-C.

Each of the duplex connectors 22,24 has a side-by-side pair of hybrid connectors, where each hybrid connector has an essentially square cross-section with the dimensions (a cross-section approximately 5 mm from side to side) and mating characteristics of a standard LC connector, as defined by the Fiber Optic Connector Intermateability Standard—Type LC, ANSI TIA/EIA 604-10A.

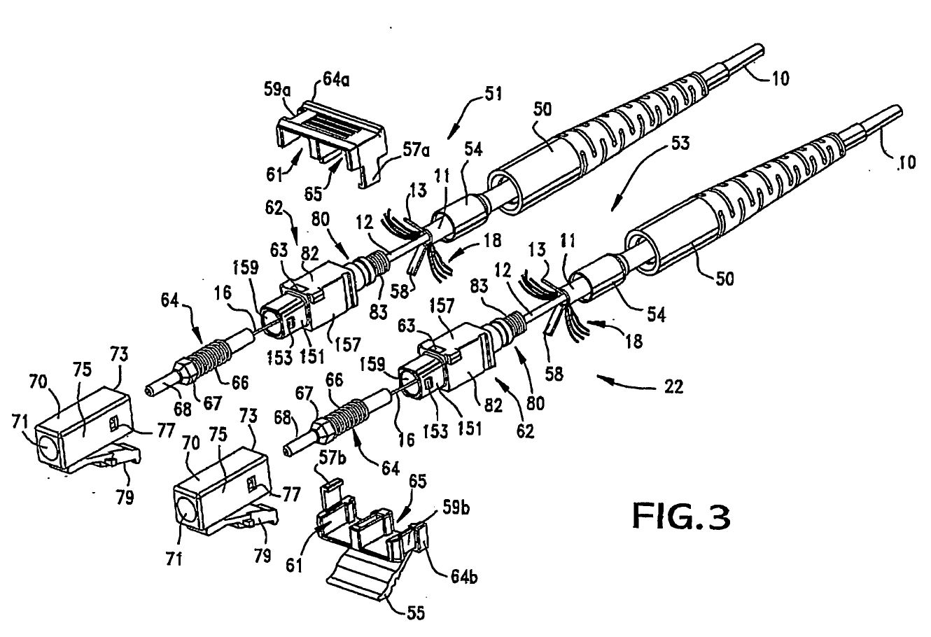

FIG. 3 is an exploded perspective view of one of the hybrid duplex LC connectors 22 of FIG. 2, illustrating in detail how the connectors 22,24 are assembled and how the electrical connections are formed inside each of the connectors 22,24.

The duplex connector 22 is an assembly include two side-by-side hybrid LC simplex connectors 51,53 held together by a duplex clip comprising two inter-engaging plastic clip halves 64a-b. Each clip half 64a-b includes an integral latch 57a-b for clipping into a mated channel 59a-b formed along the exterior of the lateral wall of the opposite clip half 64a-b. The clip halves 64a-b include parallel channels 61,63 for firmly hugging the outer surfaces of the crimp bodies 62 when the two clip halves 64a-b are clipped together.

Each of the individual hybrid LC connectors 51,53 of the duplex connector 22 is essentially identical to the other in terms of construction. Each individual hybrid connector 51,53 includes an elongated optical plug housing 70, an optical plug assembly 64 including a fiber ferrule 68, a spring retainer 67, a compression spring 66, an elongated crimp body 62, a crimp tube 54 and a boot 50. As illustrated in FIG. 2, the assembled hybrid connectors 51,53 may be axially inserted into the hybrid adapter 26 in order to couple the connector 22 to a passive or active device or another connector 24.

The elongated housing 70 includes a front end 71 having an opening and a rear end 73. An internal passageway interconnects the front end 71 and the rear end 73. The housing 70 further comprises a pair of opposed lateral sides 75, each lateral side 75 having a window 77.

The housing 70 has an essentially square cross-section with the dimensions of a standard LC connector, that is, approximately 5 mm from side to side. The general style of the housing 70 is that of the well known RJ-45 housing which contributes to the ease and familiarity of use of the connector 10.

An integrally formed spring latch 79 extends outwardly from the bottom side of the housing 70 for cooperating with a corresponding spring latch 55 extending from the bottom of the lower clip half 64b. The spring latches 79,55 cooperate together to release the housing 70 from the adapter 26, after being inserted. The spring latches 79,55 are well known devices that can be constructed in a number of different ways. The spring latches 79,55 are preferably formed so that they can be deformed somewhat by the application of force, but then return to their original shapes after the force is removed.

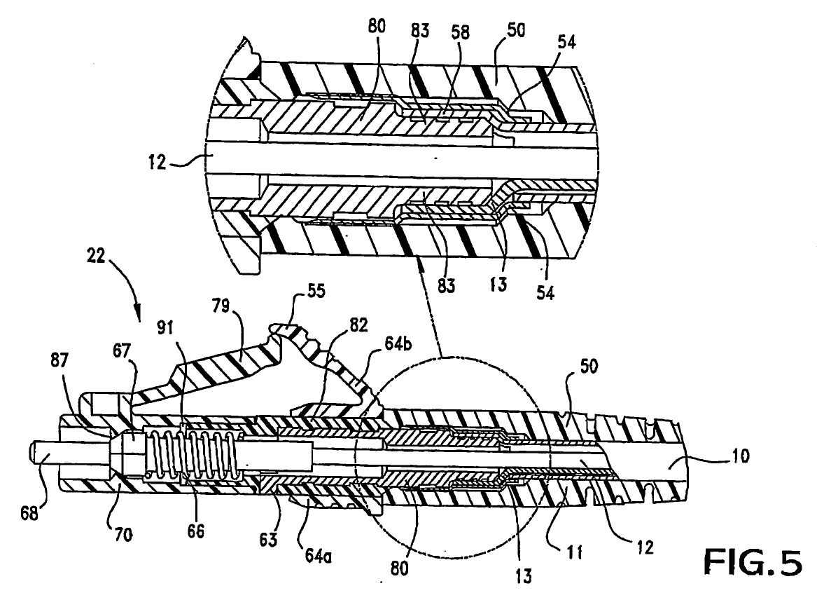

A restricted passageway 87 (see FIG. 5) opening at the front 71 of the housing 70 is provided inside of the housing 70 for receiving and retaining the optical plug assembly 64 so that the ferrule 6B is properly positioned in the connector 51. The passageway 87 is formed within the housing 70 having a size and shape so as to limit lateral and forward axial movement (toward the connector 26) of the emplaced ferrule 68. When the ferrule 68 is placed within the housing 70, the ferrule 68 protrudes beyond the front 71 of the housing 70.

Once the optical plug assembly 64 has been received in the housing 70, it is desirable that the ferrule 68 have a nominal amount of backward axial movement. Accordingly, when not coupled to another optical device or connector, the multi-fiber ferrule 68 is axially loaded so that it protrudes from the housing 70 (as shown in FIG. 5) by a loading mechanism, such as the compression spring 66.

The crimp body 62 includes a non-conductive shell 82 and a conductive insert 80. The shell 82 has a front substantially rectilinear portion 151 that is sized and configured to be received in a correspondingly sized and configure passageway 91 (see FIG. 5) at the rear end 73 of the housing 70. In particular, the portion 151 securely slides within the passageway 91 and is held in place by stops 153, which engage corresponding windows 77 in the sides 75 of the housing 70. A middle portion 157 of the shell 82, having a larger cross-section than the front portion 151, abuts the rear end 73 of the housing 70 when the crimp body 62 is inserted into the housing 70.

The conductive insert 80 extends axially within and from the rear of the shell 92 and operates as a guide for the buffer optical fiber 12 terminated by the ferrule 68 and extending through a cylindrical passageway 159 defined by the crimp body 62. The conductive insert 80 also acts a conductor within the connector 51, and to this end, includes the contact portion 63 exposed through the top of the shell 82. The exposed portion 63 makes contact with a conductor 106 inside the adapter 26 when the connector 22 is inserted therein. The exposed portion 63 is preferably a rectangular area. The conductive insert 80 is preferably made of a conductive metal, such as aluminum, brass or another copper alloy.

The exposed rear portion of the insert 80 includes a corrugated area 83 for crimping the hybrid cable 10 and making electrical contact with the cable conductor 13.

The portion of the crimp body 62 cylindrical passageway 159 defined by the rectilinear portion 151 is sized and shaped to receive and hold the compression spring 66. The spring 66 provides axial loading of the optical plug assembly 64 for maintaining positive pressure during an optical connection.

During assembly of the simplex connector 51, a portion of sheathing 58 from the hybrid cable 10, strength members 18 and cable conductor 13 are placed around the tubular corrugated neck 83 of the crimp body 62 conductive insert 80. The crimp tube 54 is then placed over the hybrid cable sheathing 58, members 18, conductor 13 and exposed rear end of the insert 80, and then compressed using, for instance, a conventional manual crimping tool, to securely the fasten the cable 10 to the crimp body 62. Details of the fully connected cable assembly are shown in FIG. 5.

The housing 70, clip halves 64a-b, ferrule assembly 67,68 and boot 50 are each preferably of unitary construction, composed of a resilient thermoplastic, so as to be light weight and durable. These parts may be fabricated using any number of suitable methods, but they are preferably molded using well known injection molding techniques.

FIG. 4 is a partial cut-away view showing details of the connector crimp body 62 included in the hybrid optical/electrical connectors 22,24 of FIGS. 2-3. The crimp body 62 includes the conductive insert 80 which is covered, in part, by a non-conductive shell 82. The crimp body 62 is preferably an insert-molded part, where the shell 82 consists of a polymeric material molded over portions of the insert 80. Alternatively, the shell 82 can be a two-part construction having two mated halves that are fastened together around the insert 80. As discussed above, the insert 80 serves as an electrical conductor inside the crimp body 62, in addition to providing its crimping and cable guiding functions.

FIG. 5 is a partial cross-sectional view of one of the hybrid connectors 22 of FIG. 2, fully assembled. This view shows the attachment of the hybrid cable 10 to the connector 22 and passage of the cable's optical fiber 12 through the connector 22, as well as attachment of the cable's conductor 13.

This view shows the cable conductor 13 crimped to the insert corrugated area 83 (i.e., at the bottom side of the insert 80) opposite the cable sheath 58, which is crimped to the top side of the corrugated area 83. Cable strength members 18 (not shown in FIG. 5) are crimped to the corrugated area 83 90° apart from the cable sheath 58 and conductor 13. Other crimping configurations are possible within the scope of the invention.

FIGS. 6A-C are various views of the hybrid LC duplex adapter 26 shown in FIG. 2.

FIG. 6A is a perspective view showing the elongated non-conductive housing 101 of the adapter 26 having side-by-side plug connector receiving channels 100,102 passing through the housing 101. The adapter housing 101 is preferably a polymeric material molded with features to accommodate easy insertion and removal of the plug connectors 22,24 into and from the channels 100,102. The housing 101 includes two mated adapter halves 103,105 that are welded together at mating surfaces 107 (FIG. 6C) with ferrule alignment sleeves 104 emplaced within the optical ports 109 of the halves 103,105. The alignment sleeves 104 are sized and shaped to receive the protruding front end portion of the ferrules 68 when the connectors 22,24 are inserted into the adapter 26.

The open ends of the receiving channels and their interior passageways through the adapter 26 are defined and shaped for receiving the connectors 22,24. In particular, the channels 100,102 are sized to correspond to the dimensions of the housing 70 and at least a portion of the crimp body 62 so as to receive and precisely guide the axial movement of the connectors 22,24 within the adapter 26. In addition, internal protrusions 117 in the channels 100,102 receive and operate in conjunction with the spring latches 79 to selectively hold the connectors 22,24 within the adapter 26.

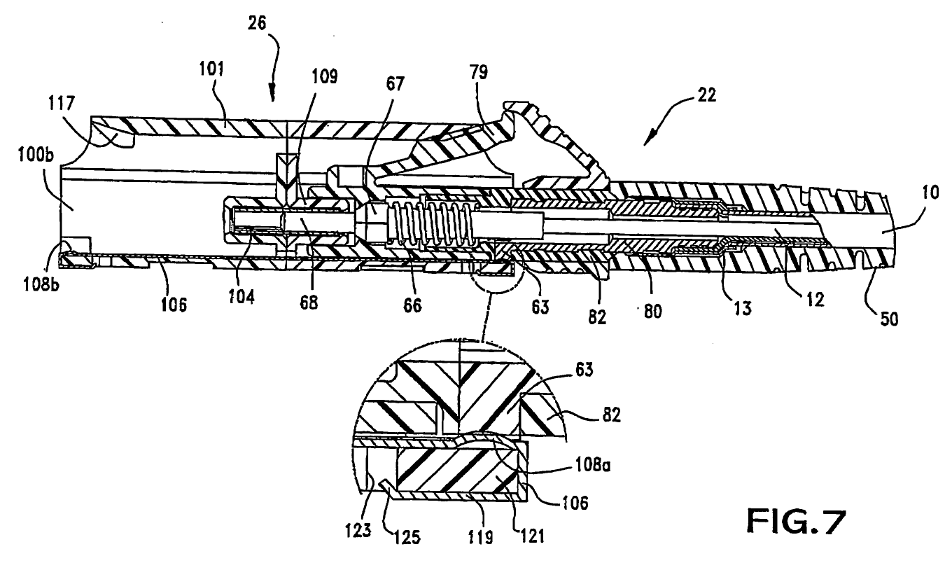

The adapter includes a pair of elongated conductors 106 respectively located within each of the plug connector receiving channels 100,102. Each conductor 106 extends longitudinally along an interior surface of its respective receiving channel 100,102. The conductors 106 each have at least one contact point within the channel, such as raised contact points 108a-b. The contact points 108a-b are positioned within the channels 100,102 so that they are aligned with the exposed contact portions 63 of the connectors 22,24 when the connectors 22,24 are inserted within the plug connector receiving channels 100,102. Thus, as illustrated in FIG. 7, when the connectors 22,24 are fully inserted into the adapter 26, the exposed contact portions 63 of the connectors 22,24 and the contact points 108a-b of the adapter 26 are in electrical engagement with one another, providing a completed electrical path through the adapter 26.

The adapter 26 includes two resilient tangs 113 extending outwardly from opposite lateral walls of one of the adapter halves 105. The tangs 113 cooperate with exterior flanges 115 on the adapter half 105 to mount the adapter 26 into an appropriately shaped panel opening, such as one found on a patch panel. To mount the adapter 26, the adapter half 105 is inserted into the panel opening, compressing the tangs 113 inwardly. After the adapter 26 is fully inserted and the panel is resting against the flanges 115, the tangs 113 spring back into their original positions, locking the adapter 26 into place.

The adapter housing 101 is preferably made of a resilient thermoplastic, so as to be light weight and durable. These parts may be fabricated using any number of suitable methods, but they are preferably molded using well known injection molding techniques. The adapter conductors 106 are preferably made of metal, such as copper or aluminum.

FIG. 6B is a cross-sectional view of the adapter 26 along section line B-B shown in FIG. 6A.

FIG. 6C is a cross-sectional view of the adapter 26 along section line A-A of FIG. 6A., showing details of one of the connector receiving channels 100. To hold the adapter conductors 106 in place, their ends 119 are bent to snuggly engage around the channel opening lips 121 of the adapter housing 101. The tip ends 125 of the conductors 106 are crimped to snuggly engage conductor mounting holes 123 formed on the exterior surface of the housing 101.

FIG. 7 is partial cross-sectional view showing one of the hybrid LC duplex connectors 22 fully inserted within the hybrid adapter 26. As the connector 22 is inserted into the receiving channel opening 100a of adapter 26, the exposed portion 63 of the crimp body 62 makes electrical contact with the conductor raised contact point 108a of the adapter 26. The adapter conductor 106 provides an electrical path to the adapter raised contact point 108b at the opposite side of the adapter 26, which can electrically connect to a mating connector (not shown) when it is inserted into the opposite receiving channel 100b.

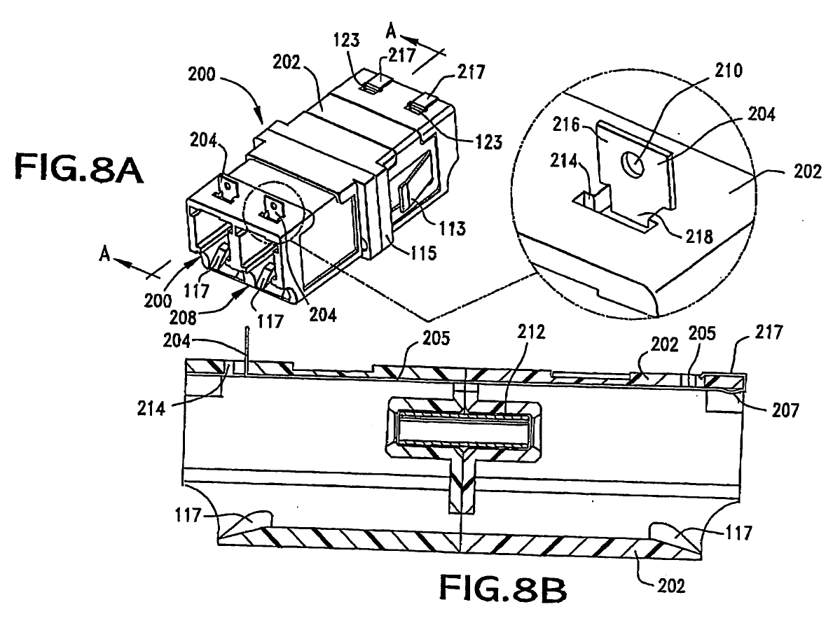

FIGS. 8A-B are various views of an alternative structure of a hybrid adapter 200, which includes external soldering joints 204, Instead of electrically connecting to two hybrid duplex LC connectors (as depicted in FIG. 7), the electrical conductors 205 in this adapter 200 are terminated in solder joints 204. The solder joints 204 can be connected to terminal equipment associated with the adapter 26. This adapter configuration 200 is particularly useful when the hybrid cable conductor 13 is used to carry electrical power.

To ease manufacturing and to also hold the solder joints 204 in place on the housing 202, a pair of T-shaped openings 214 are formed in the housing 202 for the soldering joints 204. To assemble the conductors 205 into place, each soldering joint 204 is passed through the wider portion of each T-shaped opening 214 so that the wider upper portion 216 of the soldering joint 204 is above the top surface of the housing. The conductor 205 is then moved longitudinally in the housing 202 so that narrower portion 218 of the soldering joint 204 engages the narrower portion the T-shaped opening 214. The free end 211 of the conductor 205 is then crimped around the end of the housing upper wall to fix the conductor 205 and soldering joint in place.

The preceding detailed description has illustrated the principles of the invention using a specific implementation of a duplex LC-type hybrid connector system. However, the invention is not limited to this particular embodiment. For example, the inventive principles disclosed herein can be implemented in many other types of hybrid connector systems, such as simplex connector systems or connector systems having different shapes, sizes and mating characteristics.

Therefore, while one or more specific embodiments of the invention have been described, it will be apparent to those of ordinary skill in the art that many more embodiments are possible that are within the scope of this invention. Further, the foregoing detailed description and drawings are considered as illustrative only of the principles of the invention. Since other modifications and changes may be or become apparent to those skilled in the art, the invention is not limited the exact construction and operation shown and described, and accordingly, all suitable modifications and equivalents are deemed to fall within the scope of the invention.

What is claimed is:

1. A hybrid optical/electrical connector system for connecting at least one hybrid optical/electrical cable containing an optical fiber and a conductor, comprising:
a plug connector including a crimp body having an elongated conductive insert with an interior passage for receiving the optical fiber and a non-conductive shell covering the conductive insert, the conductive insert having a contact portion exposed through the shell and an end extending beyond the shell for electrical engagement with the conductor; and
an adapter including a non-conductive housing with a plug connector receiving channel and an optical port for receiving the optical fiber when the plug connector is located within the plug connector receiving channel, a conductor extending longitudinally within the plug receiving channel, the conductor having at least one contact point within the channel in alignment with the exposed contact portion of the conductive insert so that when the plug connector is inserted within the plug connector receiving channel the exposed contact portion of the insert and the conductor contact point of the adapter are in electrical engagement with one another.

2. The connector system of claim 1, wherein the plug connector has a cross-section conforming with the outside dimensional standards for an RJ-45 plug connector.

3. The connector system of claim 1, wherein the plug connector has an essentially square cross-section with the dimensions of an LC type connector.

4. The connector system of claim 1, wherein the non-conductive shell is molded over the conductive insert.

5. The connector system of claim 1, wherein the plug connector is a duplex connector include a pair of side-by-side connectors each including a crimp body having an elongated conductive insert with an interior passage for receiving the optical fiber and a non-conductive shell covering the conductive insert, the conductive insert having a contact portion exposed through the shell and an end extending beyond the shell for electrical engagement with the conductor; and
wherein the adapter is a duplex adapter having a pair of side-by-side plug connector receiving channels adapted to receive the duplex connector, each of the plug receiving channels including a conductor extending longitudinally within the respective plug receiving channel, the conductor having at least one contact point within the channel in alignment with the exposed contact portion of the conductive insert of one of the crimp bodies so that when the duplex connector is inserted within the duplex adapter the exposed contact portion of the insert and the conductor contact point of the respective receiving channel conductor are in electrical engagement with one another.

6. The connector system of claim 5, further comprising:
a duplex clip having a pair of channels for holding the side-by-side connectors in place next to each other.

7. The connector system of claim 1, wherein the adapter conductor includes a soldering joint located externally on the non-conductive adapter housing.

8. A hybrid optical/electrical plug connector for terminating a hybrid optical/electrical cable containing an optical fiber and a conductor, comprising:
a crimp body having an elongated conductive insert with an interior passage for receiving the optical fiber and a non-conductive shell covering the conductive insert, the conductive insert having a contact portion exposed through the shell and an end extending beyond the shell for electrical engagement with the conductor of the hybrid optical/electrical cable.

9. The plug connector of claim 8, wherein the plug connector has a cross-section conforming with the outside dimensional standards for an RJ-45 plug connector.

10. The plug connector of claim 8, wherein the plug connector has an essentially square cross-section with the dimensions of an LC type connector.

11. The plug connector of claim B, wherein the non-conductive shell is molded over the conductive insert.

12. The plug connector of claim 8, wherein the plug connector is a duplex connector include a pair of side-by-side connectors for terminating a pair of hybrid optical/electrical cables, each connector including a crimp body having an elongated conductive insert with an interior passage for receiving the optical fiber and a non-conductive shell covering the conductive insert, the conductive insert having a contact portion exposed through the shell and an end extending beyond the shell for electrical engagement with a conductor included in one of the hybrid cables.

13. The plug Connector of claim 12, further comprising:
a duplex clip having a pair of channels for holding the side-by-side connectors in place next to each other.

14. A hybrid optical/electrical adapter for receiving at least one hybrid optical/electrical plug connector terminating a hybrid optical/electrical cable containing an optical fiber and a conductor, comprising:
a non-conductive housing with a plug connector receiving channel and an optical port for receiving the optical fiber when the hybrid plug connector is located within the plug connector receiving channel; and
a conductor extending longitudinally within the plug receiving channel, the conductor having at least one contact point within the channel in alignment with an exposed contact portion of a metal insert included in a crimp body of the plug connector so that when the plug connector is inserted within the plug connector receiving channel the exposed contact portion of the crimp body and the conductor contact point of the adapter are in electrical engagement with one another.

15. The adapter of claim 14, wherein the plug connector receiving channel is adapted to receive the plug connector having the dimensions of an RJ-45 plug connector.

16. The adapter of claim 14, wherein the plug connector receiving channel is adapted to receive the plug connector having the dimension of an LC type connector.

17. The adapter of claim 14, wherein the adapter is a duplex adapter having a pair of side-by-side plug connector receiving channels adapted to receive a duplex connector, each of the plug receiving channels including a conductor extending longitudinally within the respective plug receiving channel, the conductor having at least one contact point within the channel in alignment with the exposed contact portion of the conductive insert of one of the crimp bodies so that when the duplex connector is inserted within the duplex adapter the exposed contact portion of the insert and the conductor contact point of the respective receiving channel conductor are in electrical engagement with one another.

18. The adapter of claim 14, wherein the adapter conductor includes a soldering joint located externally on the non-conductive adapter housing.
